(19) United States
(12) Patent Application Publication
(10) Pub. No.: US 2025/0151891 A1
(43) Pub. Date: May 15, 2025

(54) ELECTRIC TOOTHBRUSH EQUIPPED WITH LIQUIDIZED TOOTHPASTE COLLECTION DEVICE

(71) Applicant: Jeffrey Chung, San Jose, CA (US)

(72) Inventor: Jeffrey Chung, San Jose, CA (US)

(21) Appl. No.: 18/946,764

(22) Filed: Nov. 13, 2024

Related U.S. Application Data
(60) Provisional application No. 63/598,354, filed on Nov. 13, 2023.

(51) Int. Cl. A46B 15/00; A46B 5/00; A46B 13/02; A61C 17/22

(52) U.S. Cl. CPC A46B 15/0048; A46B 5/0095; A46B 13/023; A61C 17/225

(57) ABSTRACT

An electric toothbrush includes a handle and a replaceable brush head detachably attached to the top of the handle. A bowl like device is located upon the top section of the handle so as to collect the used liquidized (waste) toothpaste therein for not flowing downward to spoil the lower section of the handle where the user's hand holds.

### FILED OF INVENTION

The invention relates to an electric toothbrush, and particularly to the electric toothbrush equipped with a collection structure to accommodate the used and liquidized toothpaste so as not to spoil the handle of the electric toothbrush for assuring that the user may efficiently hold and control the electric toothbrush during using.

### THE RELATED ART

FIGS. 1-4 show a conventional electric toothbrush made by Philps which is the trademarks of KPNV. The electric toothbrush 100 includes a body/handle 110 and a replaceable brush head 120 detachably attached to the upper end of the handle 110 wherein the handle 110 includes a metal bar 112 extending beyond the upper end thereof, and a charging port 114 at the bottom end thereof with a replaceable rechargeable battery (not shown) therein and an ON/OFF button 116 exposed on the exterior surface, and the brush head 120 includes bristles 122 at the top portion and an receiving hole 124 at the bottom end to receive the metal bar 112 therein when the brush head 120 is assembled on the handle 110. Notably, a gap 130 is formed between the handle 110 and the brush head 120 after assembled so as to allow the brush head 120 to be relatively freely vibrated during using for efficiency consideration.

Notably, the standard brushing/clean operation period lasts for two minutes each time. Because the used toothpaste is liquidized to fall down and/or flow downwardly along the brash head 120 and the handle 110 sequentially, thus spoiling the exterior surface of the handle 110 and making the exterior surface too slippery to be efficiently held by the user disadvantageously. This defect is especially true because the handle of the electric toothbrush is relatively huge to be efficiently held, compared with the regular manual tooth brush. This defect is also especially true when the user puts too much pressure on the teeth when he is brushing his teeth.

Therefore, it is desired to have an electric toothbrush equipped with the device stopping flowage of the used and liquidized toothpaste from spoiling the handle thereof, thus assuring efficiently holding and operating the electric toothbrush during using for the user.

### SUMMARY OF THE INVENTION

An electric toothbrush includes a handle and a replaceable brush head detachably attached to the top of the handle. A bowl like device is located upon the top section of the handle so as to collect the used liquidized (waste) toothpaste therein for not flowing downward to spoil the lower section of the handle where the user's hand holds.

### BRIEF DESCRIPTION OF THE DRAWINGS

FIG. 1 is an elevational view of the conventional electric toothbrush;

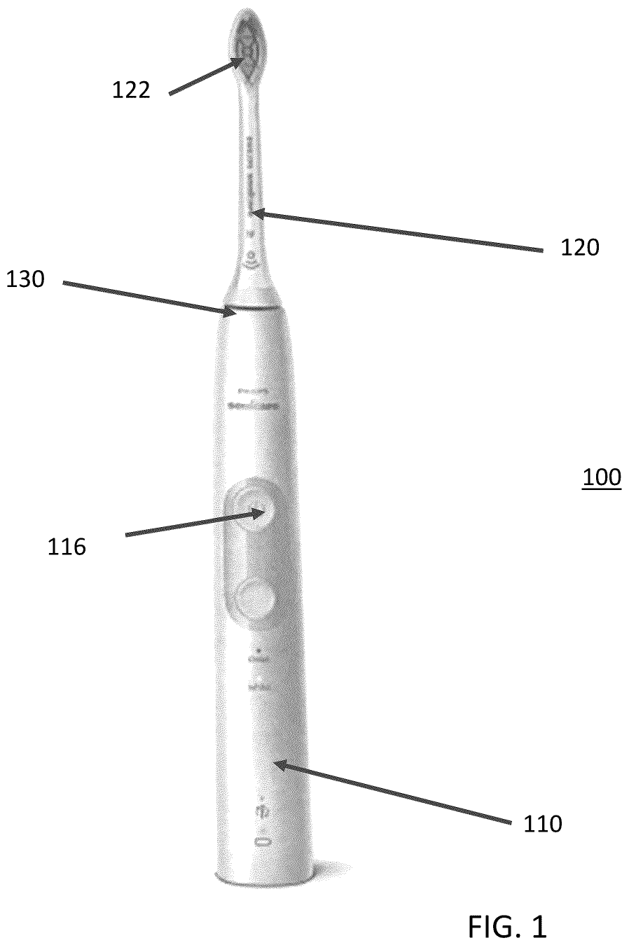

FIG. 2 is an enlarged perspective view of a top half of the electric toothbrush of FIG. 1.

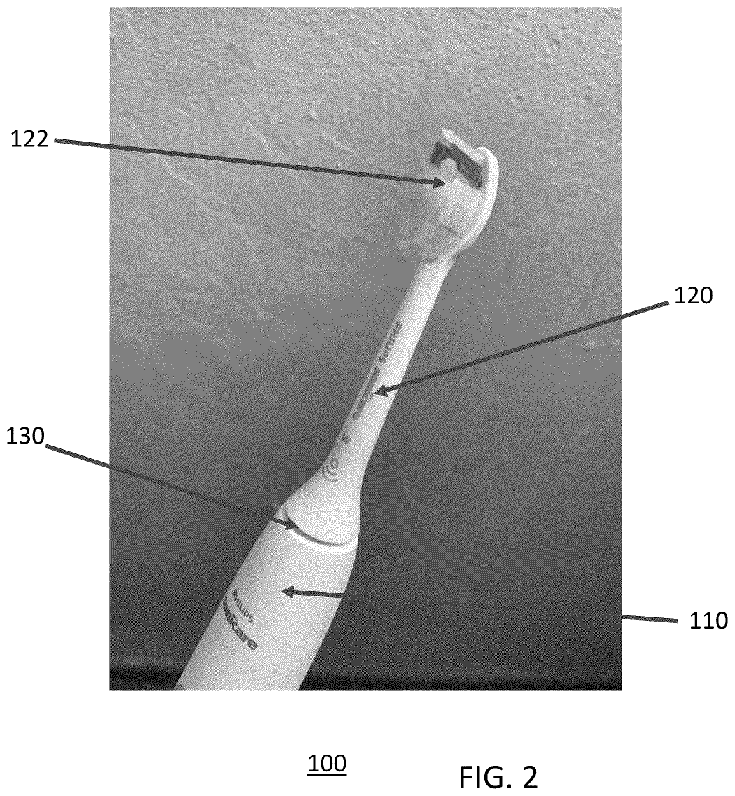

FIG. 3 is an enlarged side view of the top half of the electric toothbrush of FIG. 2;

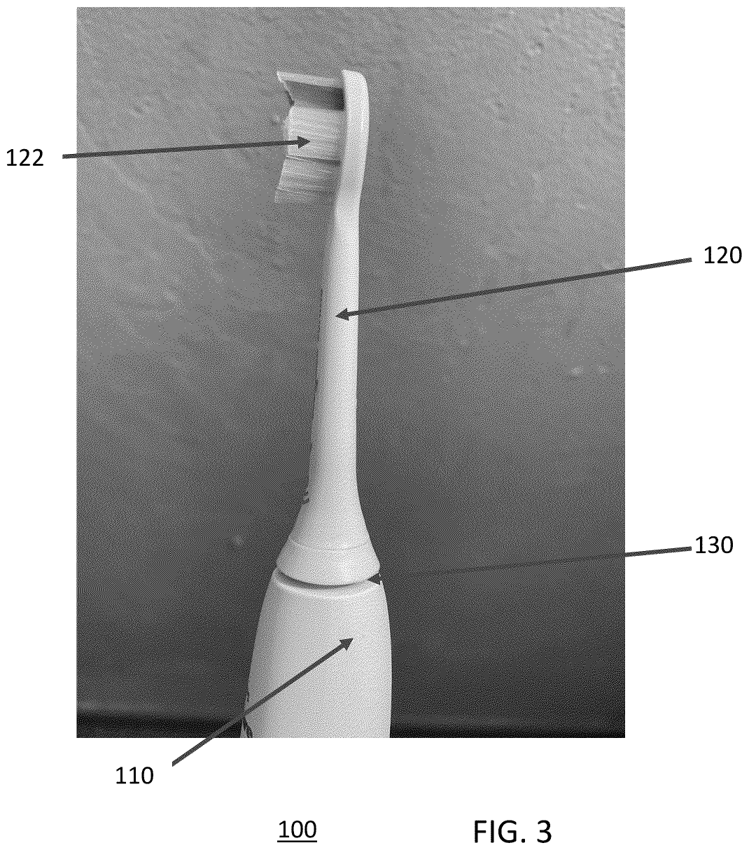

FIG. 4 is an exploded perspective view of the electric toothbrush of FIG. 1;

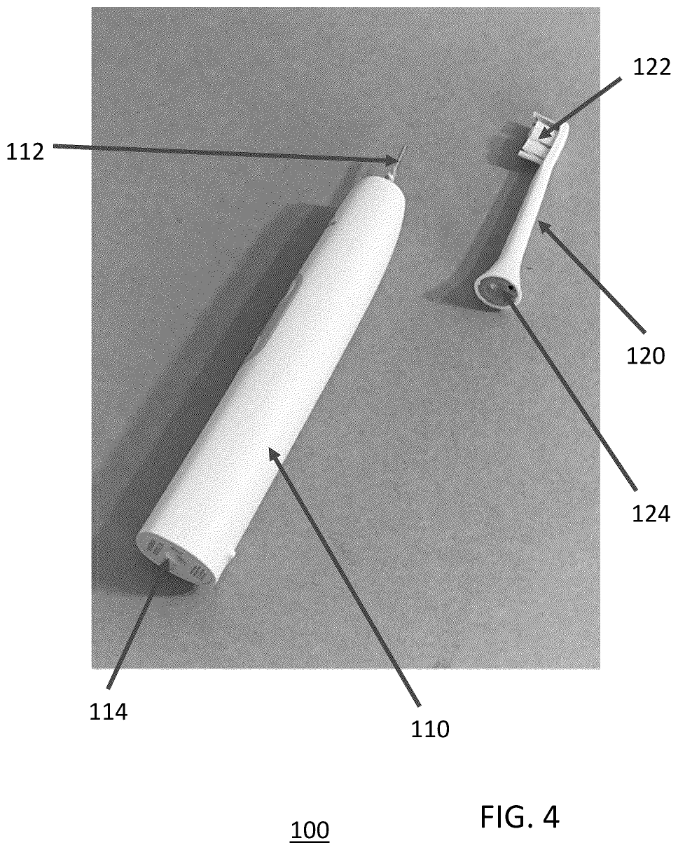

FIG. 5 is the bowl like device attachable to the electric toothbrush of FIG. 1 according to a first embodiment of the invention;

FIG. 6 is a perspective views of the top half of the electric toothbrush of FIG. 1 with the bowl like device attached thereon;

FIG. 7 is a side view of the top half o the electric toothbrush of FIG. 6;

FIG. 8 is an elevational view of an electric toothbrush according to a second embodiment of the invention;

FIG. 9 is an enlarged side view of a portion of the top half of the electric toothbrush according to a third embodiment of the invention;

FIG. 10 is an enlarged side view of the portion of the top half of the electric toothbrush of FIG. 9 to show the bowl like device is assembled thereto in an upward operation manner;

FIG. 11 is an enlarged side view of the portion of the top half of the electric toothbrush of FIG. 9 to show the bowl like device is assembled thereto in a downward deformed manner;

FIG. 12 is an enlarged side view of the portion of the top half of the electric toothbrush of FIG. 9 to show the bowl like device is assembled thereto in a completely folded manner; and

FIG. 13 is a cross-sectional view of the bowl like device of another embodiment.

### DETAILED DESCRIPTION OF THE PREFERRED EMBODIMENTS

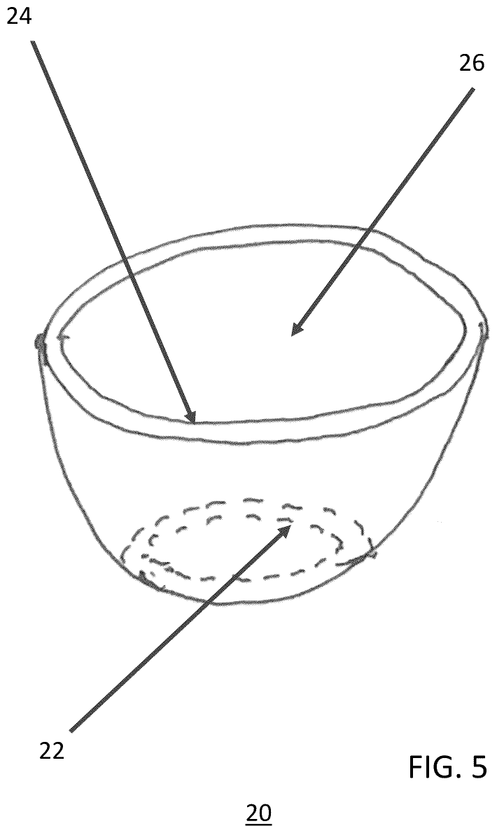

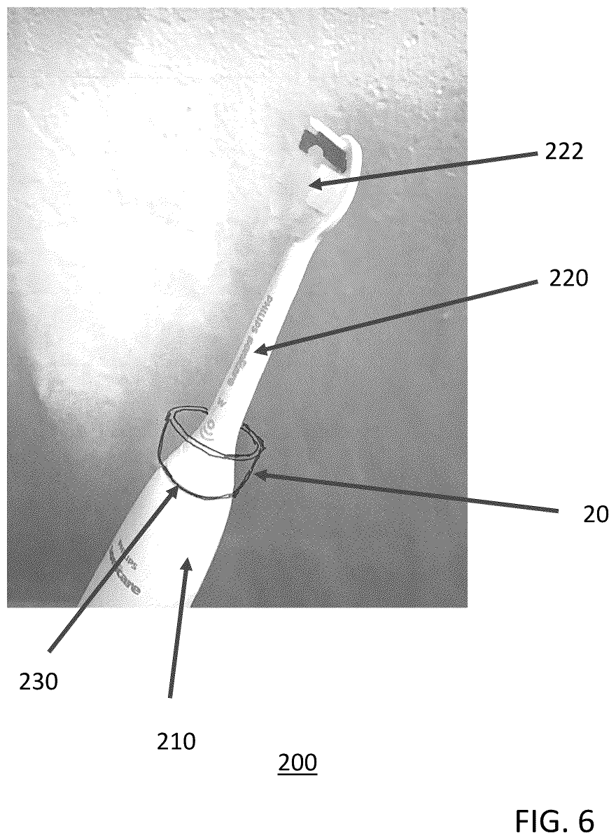

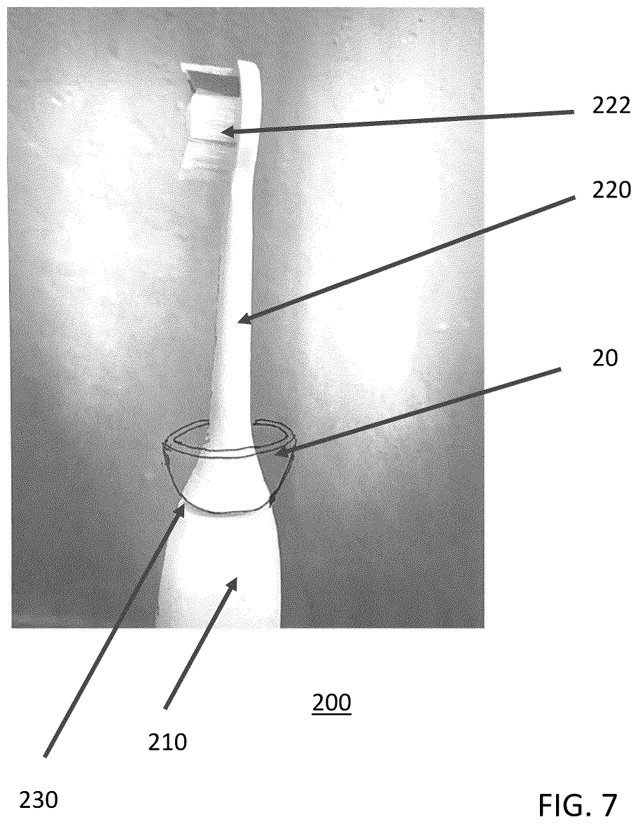

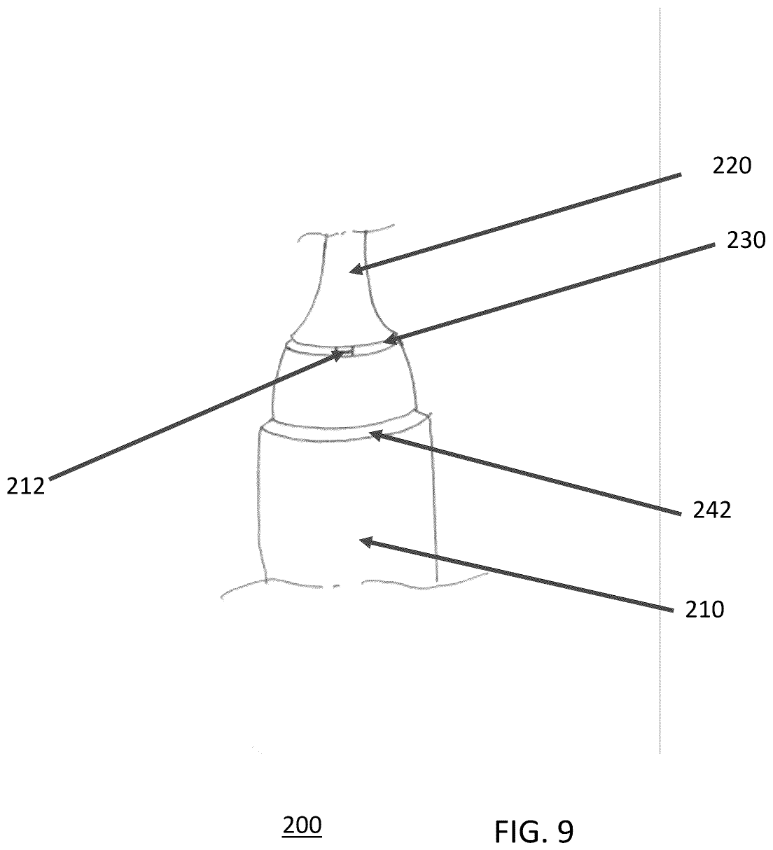

Referring to FIGS. 5-8, an electric toothbrush 200 includes a lower handle 210 with thereon an ON/OFF button 216 electrically connected to a replaceable rechargeable battery (not shown) therein, and an upper brush head 220 having the bristles 222 at the top end and detachably attached to an upper end of the handle 210 with a gap 230 therebetween. The metal bar 212 of the handle 210 is exposed in the gap 230 as shown in FIG. 9. A bowl like device 20 forms a small bottom hole 22 and a large top hole 24 wherein the top of the brush head 220 extends through and beyond the bowl like device 20 with the bottom hole 22 essentially located in the gap 230 to have the bottom face of the bowl like device 20 supportably engaged within the gap 230. Under this situation, the inner space 26 of the bowl like device 20, may surround the brush head 220 so as to allow the used and liquidized toothpaste to flow along the brush head 220 and be accommodated within the bowl like device 20 during using without further downwardly moving toward and spoil the handle 210, thus avoiding the slippery condition of the handle 210.

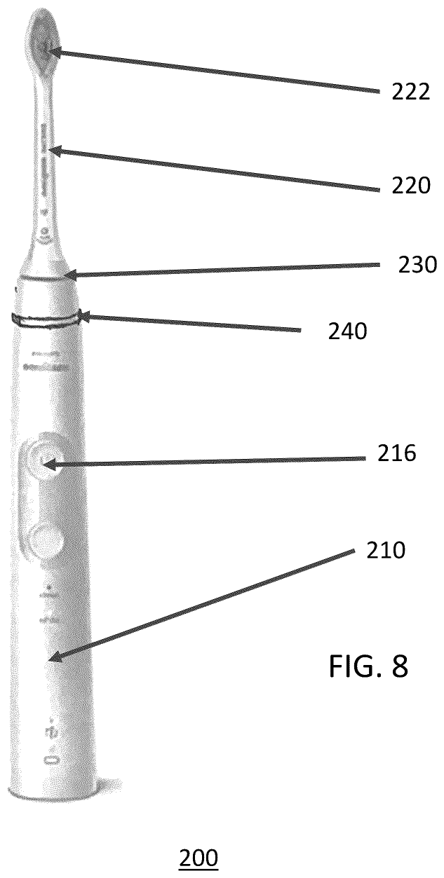

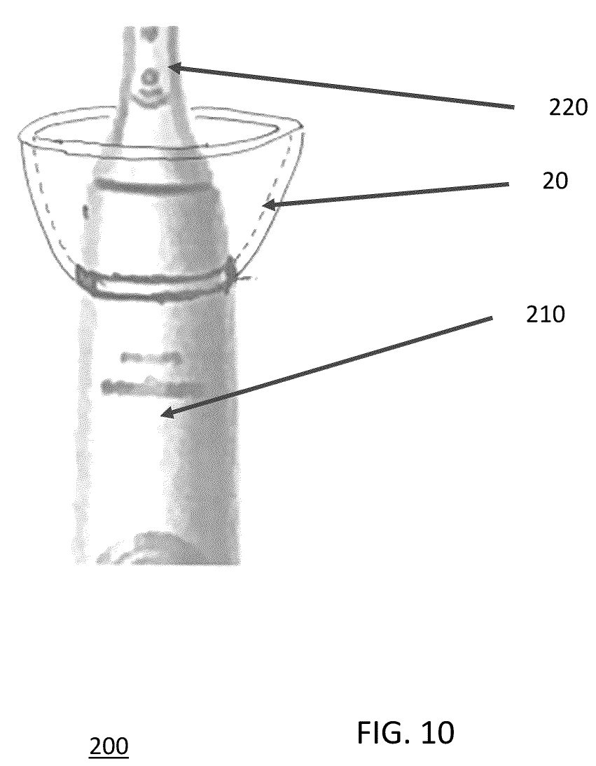

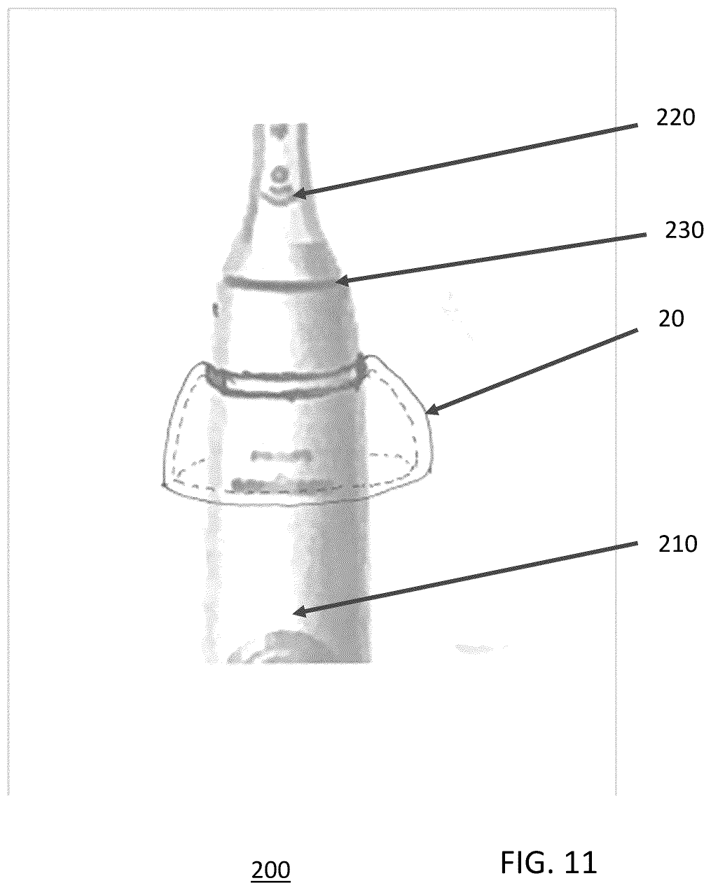

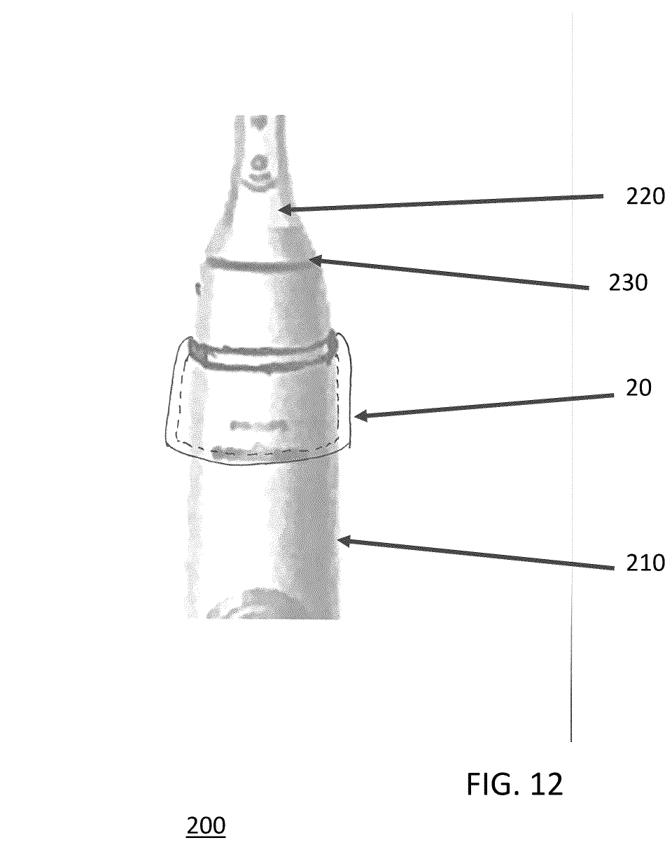

Further refereeing to FIG. 8, in the second embodiment of the invention, the bowl like device 20 is not retained to the gap 230 so as to avoid hindering vibration of the brush head 220. Instead, the handle 210 forms an annular groove 240 adjacent to the upper end thereof. FIG. 9 shows another embodiment wherein the annular groove 240 is replaced with an annular shoulder 242 against which the bottom opening 22 of the bowl like device 20 abuts. FIG. 10 shows the bowl like device 20 extends upwardly in a normal operation manner for accommodating the used/waste liquidized toothpaste so as to allow the user to hold the handle 210 efficiently during brushing the teeth. After brushing, such waste toothpaste retained in the bowl like device 20 may be flushed away by the clean water. Understandably, in this embodiment, the bowl like device 20 made by rubber, is resilient and radially expandable so as to be easily moved axially and attached to the handle 210. Additionally, the bowl like device 20 is also deflectable and deformable so as to be deflected to extend in a downward manner as shown in FIG. 11 to completely remove the waste toothpaste after using for cleaning consideration. FIG. 12 shows the bowl like device 20 is deformed to be intimately seated upon the exterior surface of the handle 210 in a folded manner for packaging and shipping consideration.

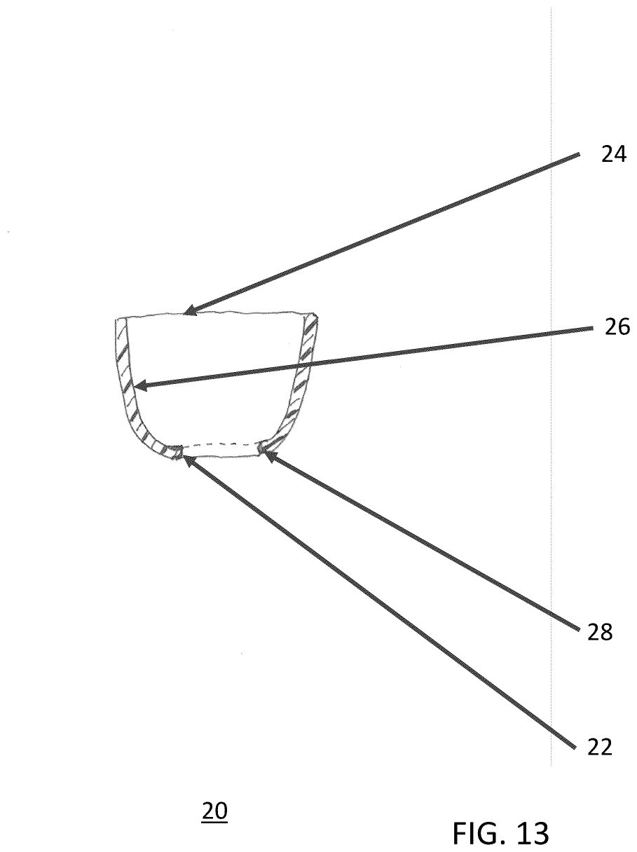

FIG. 13 shows another embodiment of the bowl like device 20 wherein a flange structure 28 is formed around the bottom hole 22 for providing enhanced retention to the handle 210.

Understandably, if properly arranged, the bowl like device may be assembled to the brush head instead of the handle. Also, if desired, the bowl like device may be unitarily formed on the electric toothbrush instead of in a detachable attachment manner.

Understandably, the invention is also applicable to the water pick device, if desired.

I claim:

1. An electric toothbrush comprising:
a handle;
a replaceable brush head detachably attached to an upper end of the handle; and
a bowl like device located around an upper portion of the handle in a surrounding manner for accommodating used toothpaste therein.

2. The electric toothbrush as claimed in claim 1, wherein the bowl like device is retained to a gap between the handle and the brush head.

3. The electric toothbrush as claimed in claim 1, wherein the bowl like device is retained to a groove in the handle.

4. The electric toothbrush as claimed in claim 1, wherein the bowl like device is retained to a shoulder on the handle.

5. The electric toothbrush as claimed in claim 1, wherein the bowl like device is deformable.

6. The electric toothbrush as claimed in claim 1, wherein the bowl like device is deflectable to extend upward or downwardly.

7. The electric toothbrush as claimed in claim 1, wherein the bowl like device is radially expandable for detachment and attachment consideration.

8. The electric toothbrush as claimed in claim 1, wherein the bowl like device is deflectable to extend along an exterior surface of the handle intimately.

9. The electric toothbrush as claimed in claim 1, wherein said bowl like device is made by rubber.

10. The electric toothbrush as claimed in claim 1, wherein the handle further includes thereon an ON/OFF button electrically connected to a rechargeable battery therein.

11. The electric toothbrush as claimed in claim 10, wherein the handle includes a charging port at the bottom electrically connected to the battery.

12. The electric toothbrush as claimed in claim 1, wherein the bowl like device is discrete from but detachably attached upon the handle.

13. An electric toothbrush comprising:
a handle,
a replaceable brush head detachably attached to a top end of the handle; and
a bowl like device detachably attached to at least one of the handle and the brush head to form an upward space therebetween for accommodating used toothpaste during using.

14. The electric toothbrush as claimed in claim 13, wherein the bowl like device is downwardly deflectable for cleaning the space.

15. The electric toothbrush as claimed in claim 13, wherein the bowl like device is radially expandable for axially assembling upon the at least on of the handle and the brush head.

16. The electric toothbrush as claimed in claim 13, wherein the at least one of the handle and the brush head forms a groove or a shoulder to retain a bottom end of the bowl like device thereto.

17. The electric toothbrush as claimed in claim 13, wherein the bowl like device is attached upon the handle.

18. An electric toothbrush comprising:
a handle,
a replaceable brush head detachably attached to a top end of the handle; and
a bowl like device located upon a circumferential surface of at least one of handle and the brush head to form a space surrounding the at least one of the handle and the brush head for accommodating used toothpaste therein during using.

19. The electric toothbrush as claimed in claim 18, wherein the bowl like device is unitarily formed on the at least one of the handle and the brush head.

20. The electric toothbrush as claimed in claim 19, wherein the bowl like device is unitarily formed on the handle.
